(19) United States
(12) Patent Application Publication
(10) Pub. No.: US 2004/0015725 A1
(43) Pub. Date: Jan. 22, 2004

(54) Client-side inspection and processing of secure content

(76) Inventors: Dan Boneh, (US); Rajeev Chawla, Union City, CA (US); Thomas D. Fountain, Redwood City, CA (US); Nagendra Modadugu, Palo Alto, CA (US); Rod Murchison, San Jose, CA (US)

Correspondence Address: PERKINS COIE LLP, P.O. BOX 2168, MENLO PARK, CA, 94026, US

(21) Appl. No.: 10/205,575

(22) Filed: Jul. 24, 2002

Related U.S. Application Data
(60) Provisional application No. 60/307,672, filed on Jul. 24, 2001.
(60) Provisional application No. 60/223,171, filed on Aug. 7, 2000.
(60) Provisional application No. 60/259,754, filed on Jan. 4, 2001.
(60) Provisional application No. 60/259,786, filed on Jan. 4, 2001.

(51) Int. Cl. H04L 9/00

(52) U.S. Cl. 713/201

(57) ABSTRACT

An apparatus and method are provided for client-side content processing such as filtering and caching of secure content sent using Transport Layer Security (TLS) or Secure Socket Layer (SSL) protocols. An appliance functions as a controlled man-in-the-middle on the client side to terminate, cache, switch, and modify secure client side content.

### BACKGROUND

Transport Layer Security (TLS) is the most widely deployed protocol for securing communications in a non-secure environment, such as on the World Wide Web. The TLS protocol is used by most E-commerce and financial web sites, and is signified by the security lock icon that appears at the bottom of a web browser whenever TLS is activated. TLS guarantees privacy and authenticity of information exchanged between a web server and a web browser. Currently, the number of web sites using TLS to secure web traffic is growing at a phenomenal rate. As the services provided on the World Wide Web continue to expand, so will the need for security using TLS.

Unfortunately, TLS and other secure protocols such as Secure Session Layer (SSL) are incompatible with many network tools and methodologies that support the Internet. For example, TLS is incompatible with existing content filters, web caches, content transformation engines, and authentication services. A brief discussion of several network tools which are incompatible with secure communications protocols now follows.

Content filters inspect requests made by an end user and the responses to those requests. For responses that contain offensive material or contain malicious code, such as a virus, the content filter prevents the response from reaching the end user. Content filters are frequently used by parents and schools wishing to prevent young children from accessing offensive sites. Content filters are also used by system administrators and Internet Service Providers (ISPs) to ensure that malicious viruses do not enter or spread through internal networks.

Web caches are located on the network between the client and the web server, typically in proximity to the client. The web cache inspects all responses coming from the server, storing and maintaining requested static content, i.e., content that changes infrequently. Examples of static content include a web page banner and the navigation buttons on the page. The next time a user requests this information, the cache can respond by providing the cached static content immediately without contacting the web server. Web caches dramatically reduce traffic on the network and reduce response times to user requests.

Content transformation engines are located at client sites and transform user web requests as they leave the user's machine. Similarly, they transform web content just before it reaches the user's web browser. For example, content transformation engines often add hypertext transfer protocol (HTTP) headers to user requests and web server responses. A content filtering device described herein is one example of a content transformation engine.

PRIOR ART FIG. 1 is a block diagram that shows a standard network architecture 100, including a proxy 102, a web server 104, a plurality of client web browsers 106, and a network 108. Proxy 102 may include content processing capabilities, such as the content filters, web caches and content transformation engines described above. Although proxy 102 is depicted as including the content processing capabilities, it will be appreciated by those of ordinary skill in the art that such processing may occur in separate modules or devices. According to the prior art, content processing may only be performed by the proxy 102 when communications between the clients 106 and the server 104 are unencrypted, i.e., effectuated through a non-secure protocol.

PRIOR ART FIG. 2 is a flow diagram showing content processing of unencrypted communications under the standard network architecture described above. To access a web page, in a step 202 the web browser first sends a request to connect to a www.xyz.com web server via the proxy. In a step 204, the proxy may perform content processing on the browser request, such as inspecting the request or determining if the response is cached, filtering the request according to established policies, and transforming the browser request. In a step 206, the proxy then forwards the processed request to the destination www.xyz.com web server. In a step 208, the proxy receives the www.xyz.com web server's response to the browser request, and in a step 210 may perform content processing on the response. Finally, in a step 212 the proxy forwards the processed response back to the web browser.

When using the TLS protocol, a TLS session between a web server and a web browser occurs in two phases, an initial handshake phase and an application data phase. Regarding the initial handshake phase, when a web browser first connects to a web server using TLS, the browser and server execute the TLS handshake protocol. This execution generates TLS session keys, including a TLS session encryption key and a TLS session integrity key. These keys are known to the web server and the web browser, but are not known to any other devices or systems.

Once TLS session keys are established, the browser and server begin exchanging data in the application data phase. The data is encrypted using the TLS session encryption key and protected from tampering using the TLS session integrity key. When the browser and server are done exchanging data, the connection between them is closed.

PRIOR ART FIG. 3 is a flow diagram of encrypted communication between a web browser and web server under the architecture of FIG. 1, and demonstrates the limitations in the existing architecture for processing of secure content. When using TLS or SSL, the proxy cannot determine the destination web site because it is encrypted. To solve this problem, in a step 302 the web browser pre-pends the message “CONNECT domain-name”, such as CONNECT www.xyz.com, before a TLS message, and in a step 304 sends the augmented message to the proxy.

As noted above, because the browser request is encrypted using a key known only to the web browser and the web server, the proxy cannot inspect or process the browser request. Accordingly, in a step 306 the proxy forwards the unprocessed TLS message to the web server identified by the browser. In a step 308, the web server decrypts the browser request, and sends an encrypted response. Again, the proxy is unable to perform processing on the encrypted communication between the web server and web browser, and in a step 310 forwards the encrypted response to the web browser. Finally, in a step 312 the web browser decrypts the server response.

The steps of the TLS initial handshake protocol between a client and a server provide context for the present invention, and are briefly described next. In describing the main steps of the initial handshake protocol, as an example, suppose the client is issuing a TLS request for the URL: https://www.xyz.com/first.html. The TLS handshake protocol begins with the client sending the server a client-hello message. The server then responds with a server-hello message. The client-hello and server-hello are used to establish the security capabilities between the client and server. If the server is to be authenticated, as it is for the present invention, the server then sends its public key server certificate. The server certificate binds the server's public-key to the server name. For example, when accessing the URL http://www.xyz.com/first.html, the server sends a certificate that identifies the server as www.xyz.com. The server certificate contains information that identifies the certificate format and name of the Certificate Authority issuing the certificate, and also contains two fields of particular interest: the server's public-key; and, the server's common name. The common name is set to the domain name of the server, which is www.xyz.com. When the client receives the server certificate it verifies that: the certificate is properly signed by a known Certificate Authority (such as VeriSign); and, the common name inside the certificate matches the domain name in the URL requested by the client. When requesting the URL http://www.xyz.com/first.html, the client verifies that the common name inside the certificate is www.xyz.com. If either of these tests fails, the client presents an error message to the user. The server may also request that the client be authenticated, in which case the client sends its public key client certificate. Once the client has the server's certificate (and if requested, the server has the client's certificate) the server and browser carry out a key exchange to establish the session encryption key and session integrity key. The TLS specification is documented in more detail in RFC 2246, “The TLS Protocol, Version 1.0”.

To reiterate, web caches and content transformation engines are ineffective when dealing with secure content, or content sent using the TLS protocol. Content passing through these devices is encrypted using TLS session keys known only to the end points, namely the web server and web browser. The web cache and transformation engine cannot interpret the encrypted data and hence cannot process the data. Consequently, the existing infrastructure, which was intended to allow the Internet to scale securely to millions of users, becomes ineffective when dealing with secure content. As a result, there is a need for a method and apparatus that supports scaling of the Internet with respect to secure content.

### BRIEF DESCRIPTION OF THE FIGURES

PRIOR ART FIG. 1 shows a block diagram of a network architecture.

PRIOR ART FIG. 2 is a flow diagram showing content processing of unencrypted communications.

PRIOR ART FIG. 3 is a flow diagram of encrypted communication between a web browser and web server.

FIG. 4 is a block diagram of a network system architecture illustrating a man-in-the middle proxy in accordance with one embodiment of the present invention.

FIG. 5 is a block diagram of a suitable hardware architecture for supporting a proxy, in accordance with one aspect of the present invention.

FIG. 6 shows a web proxy software architecture supporting client-side inspection and processing of secure content, in accordance with another aspect of the present invention.

FIG. 7 is a flow diagram for configuring a web proxy for client-side inspection and processing of secure content.

FIG. 8 is a flow diagram for client-side inspection and processing of secure content according to a first embodiment.

FIG. 9 depicts the format of a server certificate under the preferred embodiments.

FIG. 10 is a flow diagram for client-side inspection and processing of secure content according to a second embodiment.

FIG. 11 is a flow diagram for client-side inspection and processing of secure content sent by a browser under one embodiment.

FIG. 12 is a flow diagram for client-side inspection and processing of secure content received from a server under one embodiment.

### DETAILED DESCRIPTION

The present invention teaches a variety of techniques for providing client side content processing of secure network transmissions. Preferred embodiments contemplate a transparent, controlled man-in-the middle proxy which acts to establish a network transport mechanism between a client and a server that is secure across the network, appears wholly secure to the client and server, yet enables the proxy to access and manipulate the secure network transmissions. This allows the proxy to perform secure content processing such as caching, transformation, blocking, filtering and inspection. As will be readily apparent, the mechanisms of the present invention are suitable for use with common secure transport mechanisms such as TLS and SSL.

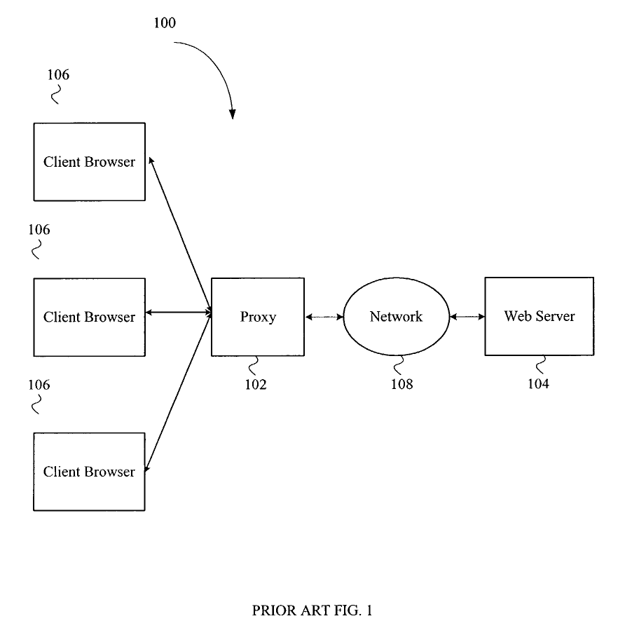

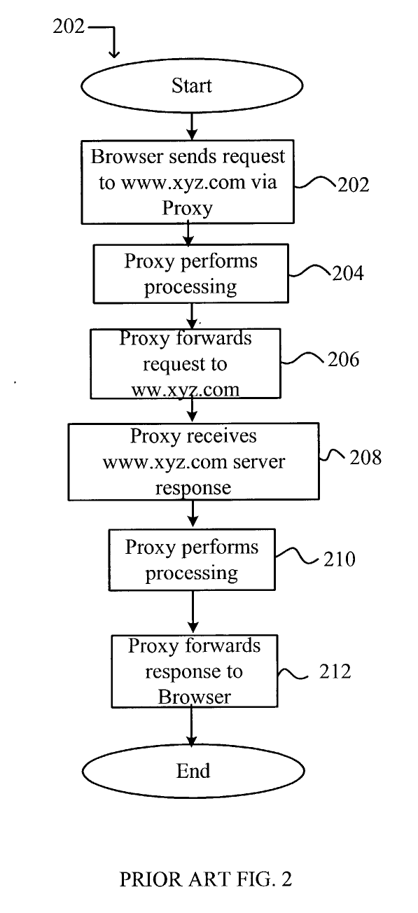

FIG. 4 shows a block diagram of a system architecture 350 according to one embodiment of the present invention. The system architecture 350 includes a man-in-the middle proxy 352, a server 104, a plurality of clients 106, and a network 108. The server 104 may be a web server or other device coupled to the network 108 for providing services to remote clients. The clients 106 may be web browsers, set-top-boxes or other such devices which request services from remote servers such as server 104 across the network 108. The network 108 may be a wide area network (WAN) such as the Internet, or any other network supporting secure transport protocols.

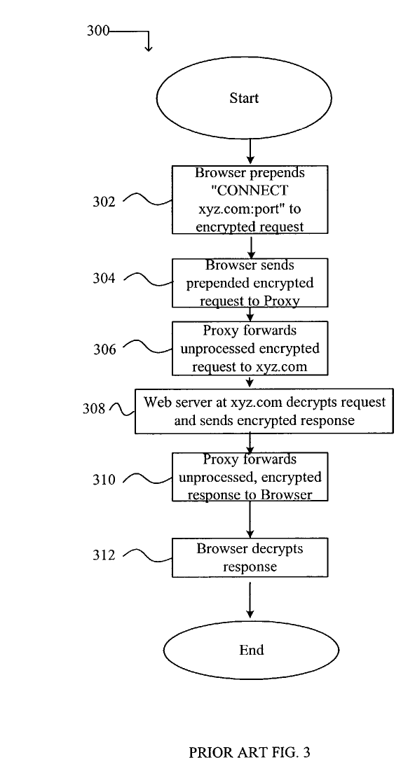

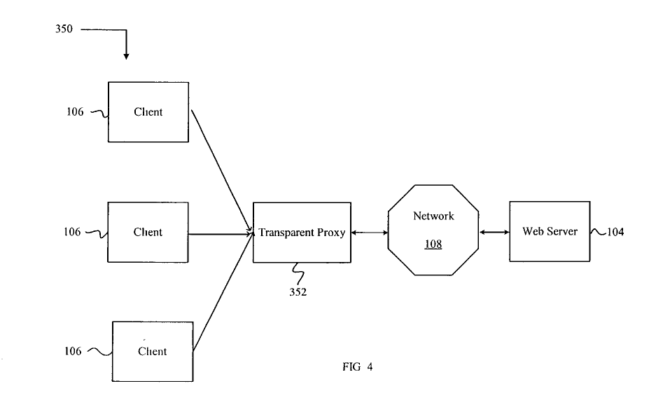

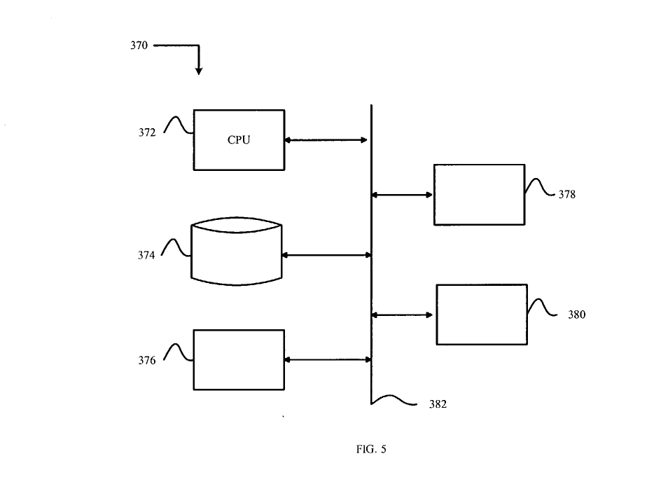

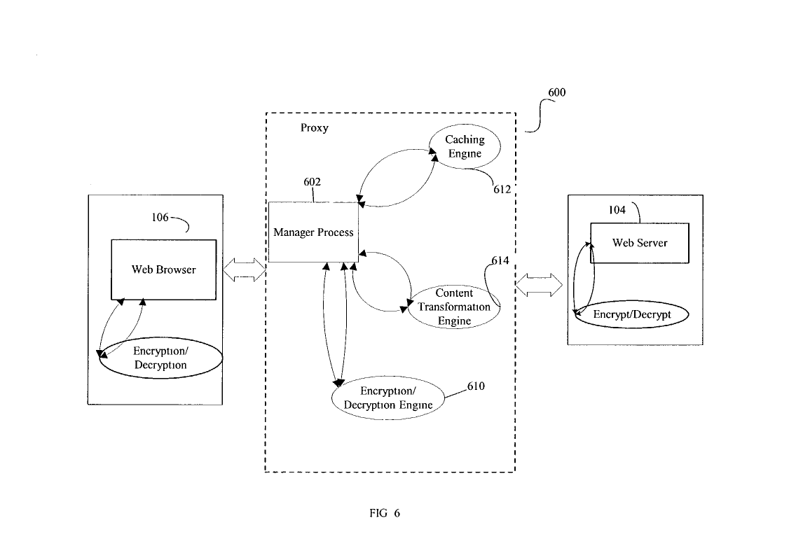

The proxy 352 of FIG. 4 may be implemented upon any suitable hardware architecture. For example, a computer system architecture having components such as the CPU, persistent and transient memory, encryption devices, and network I/O coupled together on a databus is contemplated. Alternatively, the proxy 352 may be implemented on an ASIC, DSP, or other suitable device. One particular hardware embodiment supporting the proxy 352 is described below with reference to FIG. 5. Likewise, the software architecture supporting the operation of the proxy 352 may take any suitable form. One preferred embodiment of the software architecture of the proxy 352 is described below in more detail with reference to FIG. 6.

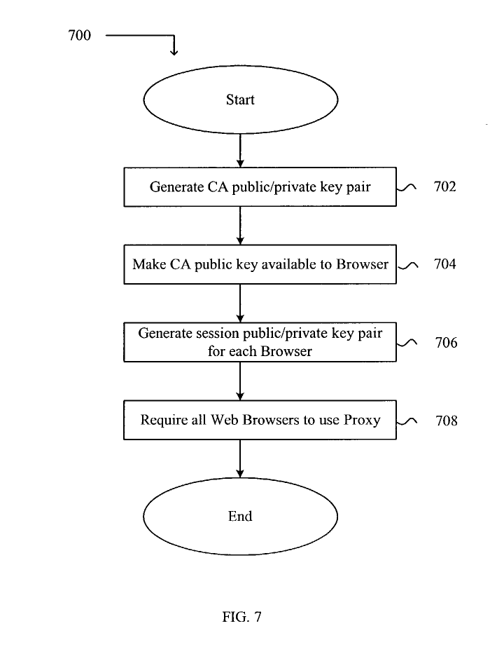

According to the present invention, the transparent man-in-the middle proxy 352 is operable to establish a transport session between the clients 106 and the web server 104 that is secure with respect to the network 108, appears secure from the perspective of the clients 106 and the web server 104, but is subject to content inspection and processing by the proxy 352. Several methods for operation of the man-in-the middle proxy and the establishment of the secure connection are described in more detail below with reference to FIGS. 7-13.

FIG. 5 illustrates a block diagram of a hardware architecture 370 suitable for supporting a transparent man-in-the middle proxy according to one aspect of the present invention. The hardware architecture 370 includes a central processing unit (CPU) 372, a persistent storage device 374 such as a hard disk, a transient storage device 376 such as random access memory (RAM), a network I/O device 378, and a encryption device 380 all bi-directionally coupled via a databus 382. As will be readily apparent, the hardware architecture is typical of computer systems and thus the proxy of the present invention is readily implementable on prior art hardware systems. Other additional components such as a graphics card, I/O devices such as a video terminal, keyboard and pointing device, may be part of the hardware architecture 370.

FIG. 6 shows a web proxy software architecture 600 of an embodiment that supports client-side inspection and processing of secure content. The proxy 600 includes a manager process 602, an encryption/decryption engine 610, caching engine 612, and content transformation engine 614. The manager process 602 utilizes the encryption/decryption engine to perform cryptographic operations on communications between the proxy 600 and the web browser 106 and web server 104. The manager process 602 further utilizes caching engine 612 and content transformation engine 614 to perform desired inspection and processing of content communicated between web browser 106 and web server 104. The proxy software architecture 600 can be implemented upon a variety of operating systems.

FIG. 7 is a flow diagram of a method 700 for configuring a transparent proxy for client-side inspection and processing of secure content in accordance with one embodiment of the present invention. When the transparent proxy is first configured, the administrator performs the following tasks. In a first step 702, a public/private key pair referred to as a Certificate Authority (CA) public/private key pair are generated on the transparent proxy. Preferably, the CA private key is stored on the proxy and is not exported from the proxy except in an encrypted format. In a step 704, the CA public key is made available to each client for which client-side inspection and processing is desired. This can be accomplished in any one of numerous ways, including posting the proxy's CA public key on an internal web site so that any user can install it into their browser client. Alternatively, every time a client computer is updated browser software containing the proxy's CA public key can be provided.

In a step 706, a second public/private key pair referred to as the session public/private key pair is generated on the transparent proxy. The session key pair is kept on the proxy and will be used to handle secure transport sessions between clients and servers via the proxy. Like the CA private key, preferably the session private key is stored on the proxy and is not exported from the proxy unencrypted. In a step 708, each client for which client-side inspection and processing is desired is configured to use the web proxy. To enforce this, the corporate firewall can be configured to block any connections to the Internet not coming from the proxy. As discussed herein, this is already very common at most corporations. Note that the order of the operations described above is not essential; for instance, the session public/private key pair may be generated before the CA public/private key pair, or may be generated when the proxy detects a request for secure communications from a web browser. Similarly, the CA public key may be pre-installed on the web browser, though it need not be.

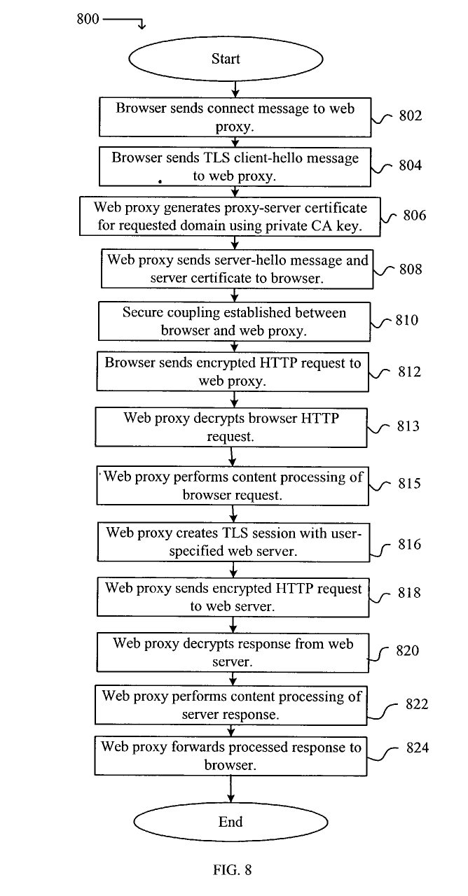

FIG. 8 is a flow diagram of a method 800 for client-side inspection and processing of secure content according to one embodiment of the present invention. The process flow of method 800 is described herein using an example that includes a user accessing web sites on the Internet using a company web proxy, but as will be readily apparent this method is applicable to any client accessing remote services via a secure network transmission. As discussed herein, this is typically the case in most enterprise networks.

As background, a user wishes to communicate with a web site www.xyz.com using TLS. Using the method described herein, the transparent proxy plays the role of a controlled man-in-the-middle. The transparent proxy sees all traffic between the user's web browser and the site www.xyz.com. With reference to FIG. 8, the session is described as follows.

In a step 802, the user's browser (i.e., client) first sends a message CONNECT www.xyz.com to the web proxy. In a step 804, the browser then sends the TLS client-hello message. The web proxy would normally forward the client-hello message to the www.xyz.com web server. However, using the methods described herein, the web proxy behaves differently, and this behavior enables inspection and processing of TLS encrypted content.

In a step 806, the web proxy uses the private CA key on the web proxy to generate a proxy-server certificate identifying itself as the domain www.xyz.com, i.e. the web proxy digitally signs the server certificate using the CA private key. The public key embedded in the proxy-server certificate is the session public key stored on the web proxy.

In a step 808, the web proxy sends a server-hello message and the proxy-server certificate generated in step 806 back to the user's browser. Note that by binding the session public key to the domain www.xyz.com in the proxy-server certificate, the web proxy is masquerading as the www.xyz.com web server to the client browser.

Typically, when the browser receives the proxy-server certificate signed by the CA private key stored on the web proxy, the web browser would not recognize the CA and the connection might be rejected. However, as described above, the web proxy CA certificate (i.e. the CA public key held by the web proxy) is installed on all user browsers. Therefore, the browsers will accept these certificates without showing any warning messages. Thus, the web proxy is a controlled man-in-the-middle device that supports users in implicitly enabling the web proxy to look at their content.

In a step 810, the browser and the web proxy complete the TLS handshake protocol to establish a secure session and TLS session keys. Note that at this point the browser thinks it is talking to www.xyz.com whereas, in fact, it is talking to the web proxy. In a step 812, the browser then sends an HTTP request intended for the web server to the web proxy via the secure session established in steps 802-810. The request is encrypted using the TLS session encryption key which is known only to the web proxy and the browser. In a step 813, the web proxy decrypts the browser request, and in a step 815 may perform any or all of the content processing previously described (e.g. inspecting a cache, filtering, content transformation).

At this point the web proxy has the browser HTTP request. In a step 816, the web proxy creates a TLS session to the site www.xyz.com. In a step 818, the web proxy sends the HTTP request created by the browser to the www.xyz.com web server using TLS.

In a step 820, the web proxy receives and decrypts a response from the www.xyz.com web server over TLS. In a step 822, the web proxy then performs desired content processing such as caching, filtering, or content transformation, and in a step 824 forwards the processed response to the browser using TLS.

FIG. 9 depicts the format of a certificate 900 that is used in the preferred embodiments, such as in the server certificate generated by the web proxy in step 806. In the preferred embodiments, the certificate 900 is an X.509 version 3 certificate. X.509 is an ITU recommendation and international standard that defines a framework for providing authentication. Referring to FIG. 9, version number field 910 indicates the version of X.509 certificate being used (generally version 3). Serial number field 920 contains a unique number associated with the CA that is the issuer of the certificate 900. Algorithm identifier field 930 indicates the algorithm used to generate the digital signature. Issuer field 940 contains the name of the issuing CA, and validity period field 950 specifies the dates between which the certificate 900 is valid. Subject field 960 contains the name of the certificate user being identified by the server certificate. Public key field 970 contains the public key of the certificate user, and certificate signature field 980 contains the digital signature of the CA issuing the certificate 900.

In a typical TLS handshake protocol between a client and a server as well understood in the art, a server responds to a client-hello message by sending a server-hello message followed by a server certificate in the format of certificate 900. For example, when accessing the URL http://www.xyz.com/first.html, the www.xyz.com server sends a certificate in which the server's common name, i.e. www.xyz.com, is stored into subject field 960. In addition, the www.xyz.com server's public key in field 970. Because the certificate is signed in field 980 by a recognized CA (such as VeriSign), the server certificate binds the www.xyz.com server's public key to its name.

With reference to FIGS. 8-9, the proxy-server certificate generated by the web proxy in step 806 of one embodiment of the present invention, and which allows the proxy to masquerade as the www.xyz.com server, will now be described in more detail. The web proxy inserts the common name of the client's destination, i.e. www.xyz.com, into the subject field 960 of the proxy-server certificate, just as the www.xyz.com server would do under operations in the prior art. However, instead of placing the www.xyz.com server's public key into public key field 970, the web proxy inserts its session public key in public key field 970. In addition, the web proxy digitally signs the proxy-server certificate with its CA private key in field 980. Because, as mentioned previously, the browser is configured to accept this proxy-server certificate, the web proxy successfully binds the destination server name (www.xyz.com) to the proxy-generated proxy session public key, allowing the proxy to thereafter masquerade as the destination server www.xyz.com.

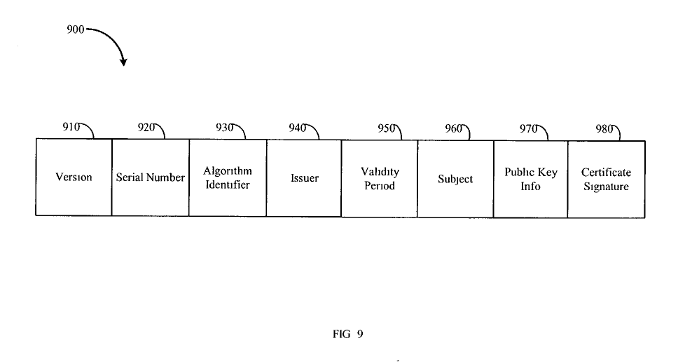

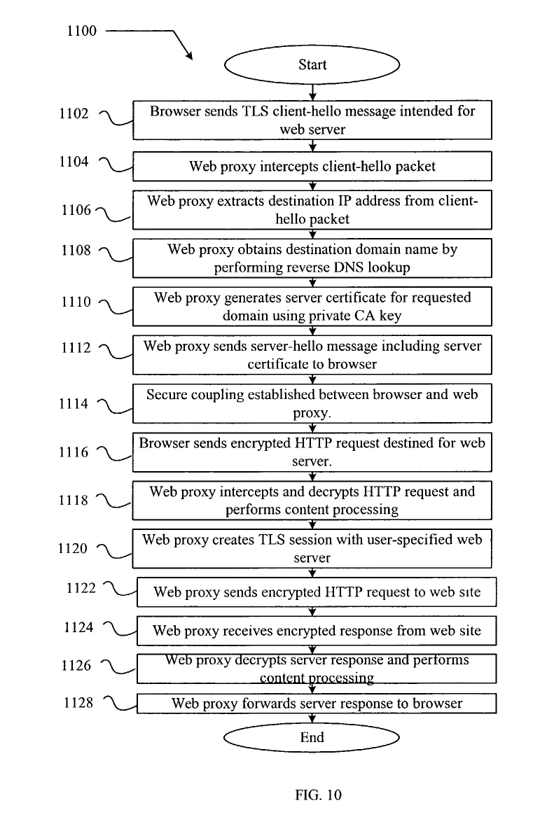

FIG. 10 is a flow diagram for client-side inspection and processing of secure content according to a second embodiment of the present invention. In this second transparent filtering embodiment, inspection and processing of secure content is possible even when the client does not explicitly pass requests through a web proxy, and secure content may be processed transparent to, and even unknown by, the web browser. With reference to FIG. 10, a transparent filtering method 1100 according to a second embodiment of the present invention is described as follows.

In a step 1102, the browser sends the TLS client-hello message destined for the www.xyz.com web server. Note that in contrast to FIG. 8, the browser does not intend to initiate a secure connection with the web server via a web proxy, and therefore does not pre-pend a CONNECT message. The TCP/IP packet containing the client-hello message is destined for the TLS port at the IP address of site www.xyz.com.

In a step 1104, the web proxy intercepts the client-hello packet and prevents it from leaving the local network through methods well known in the art. In a step 1106, the proxy extracts the destination IP address from the client-hello packet, and in a step 1108 obtains the domain name of the destination, such as by performing a reverse DNS lookup of the IP address.

Based on the information obtained in step 1108, the proxy behaves as previously described in the embodiment of FIG. 8. In a step 1110, the proxy uses the private CA key on the web proxy to generate a proxy-server certificate identifying itself as the domain www.xyz.com. The public key embedded in the server certificate is the session public key stored on the web proxy.

In a step 1112, the web proxy sends a server-hello message and the proxy-server certificate generated in step 1110 back to the user's browser. As previously described, the web proxy is masquerading as the web server at domain www.xyz.com.

In a step 1114, the browser and the web proxy complete the TLS handshake protocol to establish a secure session and TLS session keys. Note that at this point the browser thinks it is talking to www.xyz.com whereas, in fact, it is talking to the web proxy.

In a step 1116, the browser then sends an encrypted HTTP request destined for the web server. The request is encrypted using the TLS session encryption key which is known only to the web proxy and the browser. In a step 1118, the web proxy intercepts and decrypts the request, and may perform any or all of the content processing previously described (e.g. inspecting a cache, filtering, content transformation).

At this point the web proxy has the browser HTTP request. In a step 1120, the web proxy creates a TLS session to the site www.xyz.com. In a step 1122, it re-encrypts the processed request using the TLS session keys established between the web proxy and the web server, and sends the HTTP request originating from the browser to the www.xyz.com web server.

In a step 1124, the web proxy receives an encrypted response from the www.xyz.com over TLS. In a step 1126, it decrypts the response, and then performs desired content processing such as caching, filtering, or content transformation, and in a step 1128 re-encrypts the processed response and forwards it to the browser using TLS.

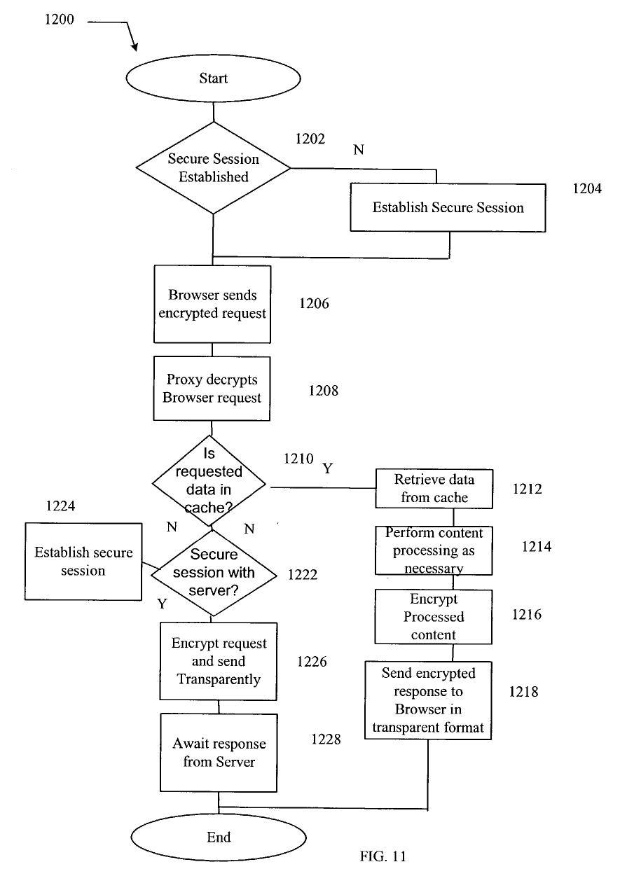

FIG. 11 is a flow diagram illustrating a method 1200 for client-side inspection and processing of secure content sent by a browser under an embodiment of the present invention. In a step 1202, the browser determines whether a secure session exists with a web server it wishes to contact. In a step 1204, if the browser does not detect a secure session, the browser establishes a secure session with the web server according to the methods described above. In a step 1206, the browser sends an encrypted request destined for the web server. In a step 1208, the proxy intercepts and decrypts the browser request, and in a step 1210 determines whether the requested response information is located in a web cache. If the response is cached, in a step 1212 the proxy retrieves the response from cache, in a step 1214 performs content processing such as filtering and transformation as desired, in a step 1216 encrypts the processed response with the browser-proxy TLS session encryption key, and in a step 1218 sends the encrypted, processed response to the browser transparently. The content processing performed by the proxy is transparent to the browser in that the browser need not be aware of the processing. If the response is not cached, in a step 1222, the proxy determines whether a proxy-server secure session exists, and in a step 1224 establishes a secure session if necessary. Once a proxy-server secure session exists, in a step 1226 the proxy encrypts the browser request using the proxy-server session encryption key and sends the encrypted request to the server transparently. In a step 1228, the proxy then awaits response from the server. As will be readily apparent, the steps described above are illustrative only, and one or more such steps may be omitted or performed in varying order.

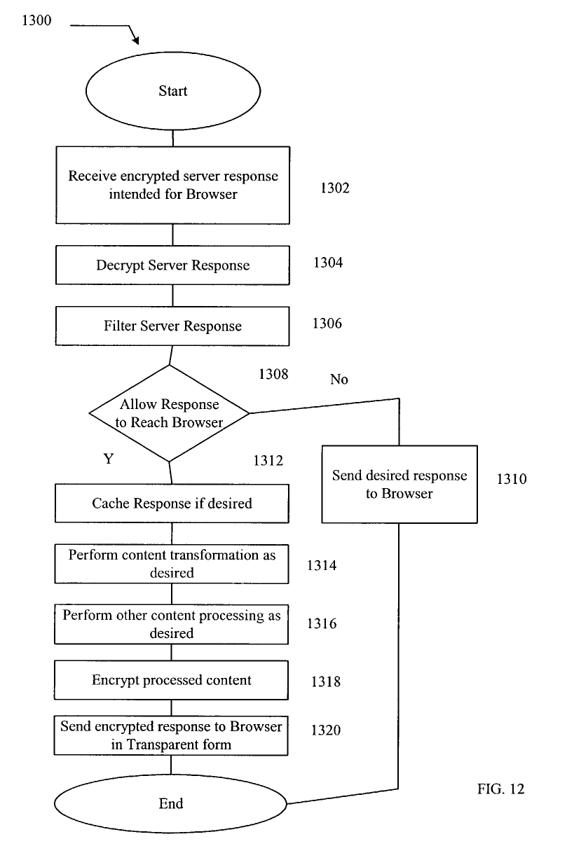

FIG. 12 is a flow diagram for client-side inspection and processing of secure content received from a server under an embodiment of the present invention. In a step 1302, the proxy receives an encrypted server response intended for the web browser, but encrypted under a session key known to the server and proxy. In a step 1304, the proxy decrypts the server response, and in a step 1306 performs optional content filtering on the decrypted response and determines in a step 1308 whether to deliver the browser requested information. If the proxy does not allow the content to be delivered to the browser, the proxy may deliver an appropriate response (e.g. error message) to the browser in a step 1310. Otherwise, in a step 1312 the proxy caches the response, in a step 1314 performs content transformation as desired, and in a step 1316 performs content processing as desired. In a step 1318, the proxy encrypts the processed server response with the client-proxy session key, and in a step 1320 sends the processed, encrypted response to the browser transparently. Again, it will be appreciated that the steps described above are illustrative only, and one or more such steps may be omitted or performed in varying order.

One skilled in the relevant art will appreciate that the concepts of the invention can also be applied when client authentication is requested. For example, the proxy may issue a client certificate request during the TLS initial handshake protocol, and require the client to respond with a client certificate. If the destination server requests client authentication, the concepts of the invention described above can be applied to cause the proxy to issue a proxy-client certificate that allows the proxy to masquerade as the client, provided that the destination server accepts this proxy-client certificate. As one example, inside a private network web servers may be configured to trust the proxy and therefor to accept proxy-client certificates generated by a proxy, thus allowing the proxy to masquerade as the client.

One skilled in the relevant art will appreciate that the concepts of the invention can be used in various environments other than the World Wide Web or the Internet. In general, various communication channels, such as local area networks, wide area networks, or point-to-point dial-up connections, may be used instead of the Internet. The system may be conducted within a single computer environment, rather than a client/server environment. The system may also be conducted over a public network or within a private intranet. Also, the user computers may comprise any combination of hardware or software that interacts with the server computer, such as television-based systems and various other consumer products through which commercial or noncommercial transactions can be conducted. The various aspects of the invention described herein can be implemented in or for any electronic environment.

Unless the context clearly requires otherwise, throughout the description, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The description of embodiments of the invention is not intended to be exhaustive or to limit the invention to the precise form disclosed. While specific embodiments of, and example uses for, the invention are described and shown herein for illustrative purposes, various equivalent modifications are possible within the scope of the invention, as those skilled in the relevant art will recognize. For example, while functions are presented in a given order, alternative embodiments may perform functions in a different order, or functions may be performed substantially concurrently. The teachings of the invention provided herein can be applied to other systems, not only the system described herein. The various embodiments described herein can be combined to provide further embodiments.

I claim:

1. A computer implemented method for client side transparent content processing, said computer implemented process comprising the acts of:
establishing a secure transport session between a client and a server via a transparent controlled man-in-the-middle proxy;
receiving, at said controlled man-in-the-middle proxy, a client request intended for said server, at least a portion of said client request being encrypted;
decrypting said client request; and
processing said decrypted client request.

2. A computer implemented method as recited in claim 1, wherein said processing includes inspecting said client request.

3. A computer implemented method as recited in claim 1, wherein said processing includes blocking said client request.

4. A computer implemented method as recited in claim 1, wherein said processing includes determining whether a response to said client request is cached.

5. A computer implemented method as recited in claim 1, wherein said processing includes performing content transformation on said client request.

6. A computer implemented method as recited in claim 5, wherein said content transformation includes content filtering.

7. A computer implemented method as recited in claim 1, wherein said client is a web browser.

8. A computer implemented method as recited in claim 1, wherein said server is a web server computer.

9. A computer implemented method as recited in claim 1, wherein the act of establishing a secure transport session includes the sub-acts of:
intercepting at said proxy a client request to establish a client-server secure session with said server computer;
establishing a client-proxy secure session between said proxy and said client computer such that said client interprets said client-proxy secure session as said requested client-server secure session; and
establishing a proxy-server secure session between said proxy and said server computer.

10. A computer implemented method as recited in claim 9, wherein said server computer interprets said proxy-server secure session as said requested client-server secure session.

11. A computer implemented method as recited in claim 9, wherein said secure sessions include the Secure Socket Layer protocol.

12. A computer implemented method as recited in claim 9, wherein said secure sessions include the Transport Layer Security protocol.

13. A computer implemented method as recited in claim 12, wherein said intercepting a client request includes receiving a CONNECT and Client-hello message.

14. A computer implemented method as recited in claim 9, wherein said establishing a client-proxy secure session comprises the acts of:
said proxy replying to said client request with a response affirming said request to establish said client-server secure session, said response including a server certificate identifying the proxy as said server.

15. A computer implemented method as recited in claim 14, wherein said establishing a client-proxy secure session further comprises the acts of:
generating a Certificate Authority (CA) public/private key pair held by said proxy;
obtaining a session public/private key pair held by said proxy;
wherein said server certificate includes said session public key and the identification of said server, and is signed using said CA private key.

16. A computer implemented method as recited in claim 15, wherein said server identification is determined from the destination address of said intercepted request.

17. A computer implemented method as recited in claim 16, wherein the destination address is the IP address and said determining includes a reverse DNS lookup.

18. A computer implemented method as recited in claim 14, wherein said establishing a client-proxy secure session further comprises the acts of:
providing for said client computer to accept said server certificate as valid.

19. A computer implemented method as recited in claim 18, wherein said providing includes installing said CA public key on said client.

20. A computer implemented method as recited in claim 18, wherein said providing includes allowing said client to access said CA public key.

21. A computer implemented method as recited in claim 9, wherein said establishing a proxy-server secure session comprises the acts of:
said proxy generating a proxy request to establish a proxy-server secure session with said server;
receiving from said server a second server certificate identifying said server; and
verifying that said second server certificate is validly signed.

22. A computer implemented method as recited in claim 21, further comprising the acts of:
in response to a server request for authentication, issuing a proxy certificate signed by a certificate authority recognized by said server.

23. A computer implemented process as recited in claim 1, further comprising the acts of:
receiving, at said proxy, a server response intended for said client computer, at least a portion of said server response being encrypted;
decrypting said server response; and
processing said decrypted server response.

24. A computer implemented method for establishing a secure transport session between a client computer and a server computer via a transparent controlled man-in-the-middle proxy, said method comprising the acts of:
intercepting at said proxy a client request to establish a client-server secure session with said server computer;
establishing a client-proxy secure session between said proxy and said client computer such that said client interprets said client-proxy secure session as said requested client-server secure session; and
establishing a proxy-server secure session between said proxy and said server computer.

25. A computer implemented method as recited in claim 24, wherein said server computer interprets said proxy-server secure session as said requested client-server secure session.

26. A computer implemented method as recited in claim 24, wherein said secure sessions include the Secure Socket Layer protocol.

27. A computer implemented method as recited in claim 24, wherein said secure sessions include the Transport Layer Security protocol.

28. A computer implemented method as recited in claim 27, wherein said intercepting a client request includes receiving a CONNECT and Client-hello message.

29. A computer implemented method as recited in claim 24, wherein said establishing a client-proxy secure session comprises the acts of:
said proxy replying to said client request with a response affirming said request to establish said client-server secure session, said response including a server certificate identifying the proxy as said server.

30. A computer implemented method as recited in claim 29, wherein said establishing a client-proxy secure session further comprises the acts of:
generating a Certificate Authority (CA) public/private key pair held by said proxy;
obtaining a session public/private key pair held by said proxy;
wherein said server certificate includes said session public key and the identification of said server, and is signed using said CA private key.

31. A computer implemented method as recited in claim 30, wherein said server identification is determined from the destination address of said intercepted request.

32. A computer implemented method as recited in claim 31, wherein the destination address includes the IP address and said determining includes a reverse DNS lookup.

33. A computer implemented method as recited in claim 29, wherein said establishing a client-proxy secure session further comprises the acts of:
providing for said client to accept said server certificate as valid.

34. A computer implemented method as recited in claim 33, wherein said providing includes installing said CA public key on said client.

35. A computer implemented method as recited in claim 33, wherein said providing includes allowing said client to access said CA public key.

36. A computer implemented method as recited in claim 24, wherein said establishing a proxy-server secure session comprises the acts of:
said proxy generating a proxy request to establish a proxy-server secure session with said server;
receiving from said server a second server certificate identifying said server; and
verifying that said second server certificate is validly signed.

37. A computer implemented method as recited in claim 36, further comprising the acts of:
in response to a server request for authentication, issuing a proxy certificate signed by a certificate authority recognized by said server.

38. A computer implemented method for client side transparent content processing, said computer implemented process comprising the acts of:
establishing a secure transport session between a client and a server via a transparent controlled man-in-the-middle proxy;
receiving, at said proxy, a server response intended for said client computer, at least a portion of said server response being encrypted;
decrypting said server response; and
processing said decrypted server response.

39. A computer implemented method as recited in claim 38, wherein said processing includes inspecting said server response.

40. A computer implemented method as recited in claim 38, wherein said processing includes blocking said server response.

41. A computer implemented method as recited in claim 38, wherein said processing includes caching at least a portion of said server response.

42. A computer implemented method as recited in claim 38, wherein said processing includes performing content transformation on said server response.

43. A computer implemented method as recited in claim 42, wherein said content transformation includes content filtering.

44. A computer implemented method as recited in claim 38, wherein said client is a web browser.

45. A computer implemented method as recited in claim 38, wherein said server is a web server computer.

46. A computer implemented method as recited in 38, wherein the act of establishing a secure transport session includes the sub-acts of:
intercepting at said proxy a client request to establish a client-server secure session with said server computer;
establishing a client-proxy secure session between said proxy and said client computer such that said client interprets said client-proxy secure session as said requested client-server secure session; and establishing a proxy-server secure session between said proxy and said server computer.

47. A computer implemented method as recited in claim 46, wherein said server computer interprets said proxy-server secure session as said requested client-server secure session.

48. A computer implemented method as recited in claim 46, wherein said secure sessions include the Secure Socket Layer protocol.

49. A computer implemented method as recited in claim 46, wherein said secure sessions include the Transport Layer Security protocol.

50. A computer implemented method as recited in claim 49, wherein said intercepting a client request includes receiving a CONNECT and Client-hello message.

51. A computer implemented method as recited in claim 46, wherein said establishing a client-proxy secure session comprises the acts of:
said proxy replying to said client request with a response affirming said request to establish said client-server secure session, said response including a server certificate identifying the proxy as said server.

52. A computer implemented method as recited in claim 51, wherein said establishing a client-proxy secure session further comprises the acts of:
generating a Certificate Authority (CA) public/private key pair held by said proxy;
obtaining a session public/private key pair held by said proxy;
wherein said server certificate includes said session public key and the identification of said server, and is signed using said CA private key.

53. A computer implemented method as recited in claim 52, wherein said server identification is determined from the destination address of said intercepted request.

54. A computer implemented method as recited in claim 53, wherein the destination address is the IP address and said determining includes a reverse DNS lookup.

55. A computer implemented method as recited in claim 51, wherein said establishing a client-proxy secure session further comprises the acts of:
providing for said client computer to accept said server certificate as valid.

56. A computer implemented method as recited in claim 55, wherein said providing includes installing said CA public key on said client.

57. A computer implemented method as recited in claim 55, wherein said providing includes allowing said client to access said CA public key.

58. A computer implemented method as recited in claim 46, wherein said establishing a proxy-server secure session comprises the acts of:
said proxy generating a proxy request to establish a proxy-server secure session with said server;
receiving from said server a second server certificate identifying said server; and
verifying that said second server certificate is validly signed.

59. A computer implemented method as recited in claim 58, further comprising the acts of:
in response to a server request for authentication, issuing a proxy certificate signed by a certificate authority recognized by said server.

60. A computer system comprising:
a data communications bus;
a central processing unit bi-directionally coupled to said data communications bus;
transient memory bi-directionally coupled to said data communications bus;
persistent memory bi-directionally coupled to said data communications bus;
a network i/o device bi-directionally coupled to said data communications bus; and
a caching process executing on said computer system;
a content transformation process executing on said computer system;
a encryption/decryption process executing on said computer system;
a proxy manager process executing on said computer system, wherein said manager process utilizes said caching, content transformation, and encryption/decryption processes to transparently process messages intercepted over a secure session link established between a client computer and a server computer via said computer system.

61. A data structure for use in the inspection and processing of secure content by a proxy coupled between a web browser and a web server, said data structure comprising:
the identification of said server;
a session public key held by said proxy;
a digital signature signed by a Certificate Authority private key held by said proxy.

62. A web browser for use in the client-side inspection and processing of secure content transmitted between said browser and a web server by a proxy, wherein:
said browser is adapted to accept a server certificate identifying said proxy as said server.

63. A computer implemented method as recited in claim 15, wherein said obtaining includes generating a session public/private key pair.

64. A computer implemented method as recited in claim 15, wherein said obtaining includes retrieving a commonly used session public/private key pair held by said proxy.

65. A computer implemented method as recited in claim 30, wherein said obtaining includes generating a session public/private key pair.

66. A computer implemented method as recited in claim 30, wherein said obtaining includes retrieving a commonly used session public/private key pair held by said proxy.

67. A computer implemented method as recited in claim 52, wherein said obtaining includes generating a session public/private key pair.

68. A computer implemented method as recited in claim 52, wherein said obtaining includes retrieving a commonly used session public/private key pair held by said proxy.
